(19) United States
(12) Patent Application Publication
(10) Pub. No.: US 2012/0079807 A1
(43) Pub. Date: Apr. 5, 2012

(54) METHOD FOR PRODUCING SOLID COMPOSITE ALUMINIZED PROPELLANTS, AND SOLID COMPOSITE ALUMINIZED PROPELLANTS

(75) Inventors: Helene Blanchard, Bourg la Reine (FR); Marie Gaudre, Le Haillan (FR); Jean-Francois Guery, Fontainebleau (FR); Guillaume Fouin, Montrouge (FR); Stany Gallier, Erceville (FR)

(73) Assignee: SME, Paris (FR)

(21) Appl. No.: 13/377,767

(22) PCT Filed: Jun. 29, 2010
(86) PCT No.: PCT/FR2010/051364

§ 371 Date: Dec. 12, 2011

(30) Foreign Application Priority Data
Jul. 1, 2009 (FR) 0954501

(51) Int. Cl. F02K 9/24; C06B 29/22; C06B 21/00

(52) U.S. Cl. 60/253; 264/3.1; 149/76

(57) ABSTRACT

The main subjects of the present invention are:
a process for obtaining a solid composite propellant (with a polyurethane binder filled with ammonium perchlorate and with aluminum): characteristically, the ammonium perchlorate charge of said propellant is obtained from at least two charges each having a specific monomodal particle size distribution. It is thus sought to reduce the thrust oscillations and the alumina deposits at the back of the engine;
a solid composite propellant, the solid propellant charges and the associated rocket engines.

The main subjects of the present invention are:
a process for obtaining a solid composite propellant (with a polyurethane binder filled with ammonium perchlorate and with aluminum),
such a solid composite propellant, the associated solid propellant charges and rocket engines.

The invention lies in the field of solid propellant propulsion and relates more particularly to solid composite aluminized propellants.

The targeted applications essentially concern solid propellant engines for space launchers (launcher accelerators or stages).

The aim of the invention is to reduce the alumina deposits at the back of engines with an integrated nozzle and to seek to reduce the thrust oscillations of aerodynamic origin while at the same time maintaining the ballistic properties, especially the rates of combustion, of the propellant close to those of the industrial propellants for space application known to date.

Solid propellant engines for space launchers are of the type of those of the rocket Ariane 5 or of the American space shuttle, of large dimensions (h ˜20 m, D ˜5 m), with an integrated nozzle. The solid propellant charges contained in engines of this type have a mass ranging from a few hundred kilograms to several hundred tons. Their operating time is from the order of a few tens of seconds to a few minutes. The present invention lies in this context of large-sized solid propellant engines.

The solid propellants for these applications are composite propellants with an inert binder of the polyurethane type. They contain a charge of ammonium perchlorate (oxidizing charge) and a charge of aluminum (reducing charge). The ammonium perchlorate oxidizing charge contained in said propellants is generally formed from several ammonium perchlorate charges with various monomodal particle size distributions that have been added during the preparation of said propellants. This may likewise be the case for the aluminum reducing charge. This family of propellants is the one with which the present invention is concerned. The weight ratios of these ingredients are generally about 68% of ammonium perchlorate, 20% of aluminum and 12% of binder.

The rate of combustion of the solid propellant depends on the pressure P prevailing in the combustion chamber and conventionally follows a law (known as Vieille's law) expressed in the form:

Vc=aPⁿ.

Said rate of combustion Vc and the pressure exponent n of the propellant are fundamental parameters for the ballistic control of a solid propellant engine (combustion time, thrust, combustion stability, etc.).

The standard values of the ballistic parameters for the propellant applications with which the present invention is concerned, using composite aluminized propellants with a polyurethane binder, are a rate of combustion Vc from a few mm/s to 10 mm/s and a pressure exponent n=0.2 to 0.4, within an operating pressure range from 3 to 10 MPa.

A person skilled in the art knows how to select the particle sizes of the raw materials constituting the solid propellant to control the levels of rate of combustion of said solid propellant.

M. M. Iqbal and W. Liang, in the Journal of Propulsion and Power, vol. 23, No. 5, September 2007, addressed the effect of the ammonium perchlorate particle size on the rate of combustion of solid propellants. Their objective was to validate a mathematical model of surface combustion, making it possible to predict the rates of combustion of this type of propellant.

L. Massa and T. L. Jackson, in the Journal of Propulsion and Power, vol. 24, No. 2, March-April 2008, addressed the effect of the aluminum particle size on the rate of combustion of solid propellants. Their objective was also to validate a mathematical model of surface combustion, making it possible to predict the rates of combustion of this type of propellant.

These two publications give no information regarding the particle size of the alumina generated after the combustion of the propellants and regarding the technical problems associated with this particle size (see later). Moreover, the various ammonium perchlorate charges that are under consideration in said publications are characterized by only one parameter, namely the particle diameter at the maximum of the peak of their particle size distribution.

Composite aluminized propellants produce, during their combustion, gases and solid particles very predominantly formed of alumina (about 30% of the mass ejected by the thruster).

The combustion of aluminum to alumina in composite propellants has been widely studied. However, a person skilled in the art does not know how to control the particle size of the alumina produced by said combustion of the propellant.

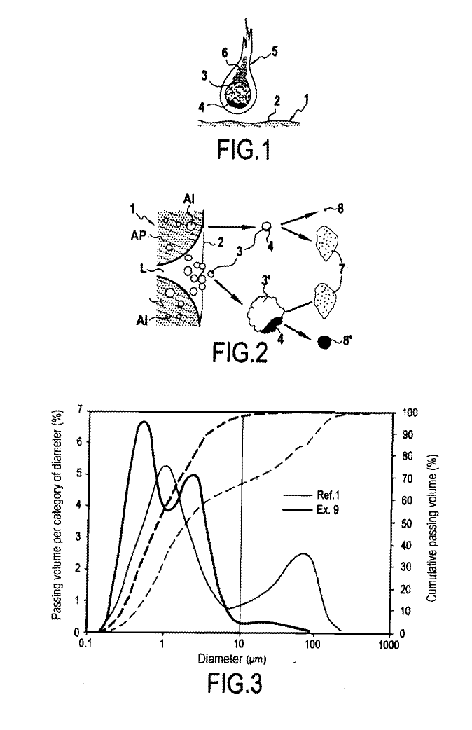

The aluminum introduced into solid composite aluminized propellants is in the form of more or less spherical grains, with a median diameter generally of between 1 and 50 μm. The combustion of a drop of aluminum, expelled from the combustion surface, is represented schematically in the attached FIG. 1. A flame surrounds the drop of aluminum and an alumina cap is formed at the bottom of the drop. The combustion generates alumina fumes (small-sized drops, of about 1 μm) and larger-sized alumina drops originating from the cap, which explains the bimodal particle size distributions of alumina finally produced by the solid propellants. The studies conducted on the combustion of these aluminized propellants (FIG. 2 explains, in graph form, the phenomena involved) show that the aluminum particles that escape from the surface of the propellant are liable to agglomerate to form drops much larger in size than that of the aluminum introduced. The residue leaves the surface without agglomerating. Laboratory observations show that the particle size distribution of the combustion residues generated by a composite aluminized propellant generally has two peaks, a main one centered at about a diameter of 60 μm and a second one centered at about 0.5 μm to 3 μm, independently of the particle size of the aluminum introduced. The percentage of the total volume represented by particles larger than 10 μm in diameter is typically about 30%.

The alumina generated by combustion of the aluminized propellant represents, as indicated above, about 30% of the mass ejected by the thruster.

In a first aspect, the production of alumina particles of large diameter (>10 μm) leads, in the case of space thrusters equipped with an integrated nozzle, to accumulation at the back resulting in a reduction in impulse. It is estimated that more than 0.5% of the mass of the propellant is thus found in the form of alumina trapped at the back, and thus not ejected from the engine. Specifically, the larger particles have high aerodynamic drag, do not follow the flow lines and are trapped at the back of the engine (in the form of a bowl formed by the integrated structure of the nozzle). This unexpelled mass penalizes, on the one hand, the engine efficiency and can, on the other hand, generate, after the engine has switched off and via a phenomena of jettisoning in space, orbital debris of alumina of appreciable size (i.e. >a few millimeters).

A person skilled in the art thus wishes to have available a solid propellant that generates alumina of fine particle sizes, since smaller particles will better follow the flow lines to be ejected by the nozzle, thus avoiding their accumulation at the back of the engine.

In a second aspect, problems of aerodynamic instability inherent to the internal geometry of large-sized solid-propellant engines may arise (side injection of the combustion products, confluence of jets, geometrical accidents or flapping of protruding components, etc.). These aerodynamic instabilities may interact with the combustion of the propellant and/or the acoustics of the combustion chamber and induce resonance phenomena. Such phenomena result in mechanical vibrations on the payload of the launcher. It is thus always sought to reduce these phenomena in order to preserve the payload.

A person skilled in the art has sought by various means, all penalizing, to reduce these aerodynamic instabilities. One method consists in introducing into the flow obstacles such as bafflers, inserts or resonance rods, and cavities (documents FR 2 844 557, U.S. Pat. No. 3,795,106 and FR 2 764 645 may be seen in this respect). The use of these methods requires development tests and always takes place to the detriment of the engine efficiency, due to an increase in the on board inert mass.

More recently, according to complex theoretical considerations, it has been demonstrated that, in the case of large-sized engines, the production of alumina of small particle size (diameter ˜1 μm) should be favored, in order to reduce these aerodynamic instabilities.

A person skilled in the art thus wishes to have available solid aluminized propellants which produce, by combustion, alumina of small diameter (thus promoting the reduction of the thrust oscillations in solid-propellant thrusters and having the combined positive effect of reducing the deposit at the back of the nozzle) while at the same time conserving ballistic properties, especially combustion rates, similar to those of the industrial propellants for space application known to date.

In the rest of the document, all the particle size data are derived from measurements taken using a photon correlation optical granulometer (PCS-DLS: Photon Correlation Spectroscopy-Diffusion Light Scattering), according to a procedure defined by standard NF 11-666.

The results of the particle size measurements for a particle size category are expressed in the form of curves, giving: on the one hand, the histogram of the volume percentages of particles (also known as the percentages of passing volume) as a function of the diameter (equivalent spherical diameter) of the particles and, on the other hand, the sum of the volume percentages of particles as a function of the diameter (equivalent spherical diameter) of the particles, the sum taken according to increasing diameters.

Three characteristic values of the analyzed sample are recorded on the cumulative curve of the volume percentages:
D₁₀: diameter for which the cumulative volume percentage is equal to 10%;
D₅₀: diameter for which the cumulative volume percentage is equal to 50%;
D₉₀: diameter for which the cumulative volume percentage is equal to 90%.

A particle size category of a particulate material is thus defined by its particle size envelope defined by minimum and maximum values of D₁₀, D₅₀ and D₉₀.

The present invention relates to solid propellants:
with a polyurethane binder containing an ammonium perchlorate charge and an aluminum charge,
having ballistic properties (Vc, n) adequate for propulsion applications, and
generating, during their combustion, alumina particles of small particle size.

The Applicant has succeeded in selecting and combining various (monomodal) particle sizes of ammonium perchlorate such that, during the combustion of the propellant, the agglomeration of aluminum in combustion is limited, for the purpose of reducing, or even virtually eliminating, the production of particles larger than 10 μm in diameter, while at the same time conserving the standard values of the ballistic parameters for a space propulsion application.

By virtue of the fine particle size of the alumina produced by the solid propellants (in combustion) of the present invention, the deposits at the back of the engines are reduced and the pressure oscillations are attenuated.

A first subject of the present invention is a process for obtaining a solid composite propellant, said process comprising:
the production of a paste by blending, in a mixer, a mixture containing a liquid polyol polymer (generally present in the mixture in a proportion of from 5% to 15% by weight and more generally in a proportion of from 7% to 14% by weight), an oxidizing charge of ammonium perchlorate (generally present in the mixture in a proportion of from 40% to 80% by weight and more generally in a proportion of from 60% to 75% by weight), a reducing charge of aluminum (generally present in the mixture in a proportion of from 15% to 20% by weight and more generally in a proportion of from 16% to 19% by weight), at least one agent for crosslinking said liquid polyol polymer in an amount such that the NCO/OH bridging ratio is between 0.8 and 1.1, is advantageously 1, at least one plasticizer and at least one additive (said crosslinking agent(s), plasticizer(s) and additive(s) generally being present in the mixture in a proportion of less than 5% by weight and more generally in a proportion of from 1% to 3% by weight);
pouring of the paste obtained into a mold;
thermal crosslinking of said paste in said mold.

Characteristically, said oxidizing charge of ammonium perchlorate in said paste results from the introduction, into said mixer, separately or as a mixture, of at least:
a first charge whose monomodal particle size distribution (“category A”) has a D₁₀ value of between 100 μm and 110 μm, a D₅₀ value of between 170 μm and 220 μm and a D₉₀ value of between 315 μm and 340 μm, and
a second charge whose monomodal particle size distribution (“category B”) has a D₁₀ value of between 15 μm and 20 μm, a D₅₀ value of between 60 μm and 120 μm and a D₉₀ value of between 185 μm and 220 μm; and, optionally,
a third charge whose monomodal particle size distribution (“category C”) has a D₁₀ value of between 1.7 μm and 3.6 μm, a D₅₀ value of between 6 μm and 12 μm and a D₉₀ value of between 20 μm and 32 μm.

The process of the invention is an analogy process which comprises, conventionally, the production of a paste from the constituent ingredients of the targeted propellant, the pouring of said paste into a mold and its crosslinking by heat treatment (baking). The ingredients under consideration are ingredients that are standard for this type of propellant. They comprise:
a liquid polyol polymer: preferably, said polyol polymer is a hydroxytelechelic polybutadiene;
an oxidizing charge of ammonium perchlorate (AP);
a reducing charge of aluminum (Al);
at least one agent (generally liquid) for crosslinking said polyol polymer: said at least one crosslinking agent (at least bifunctional) is generally chosen from polyisocyanates, and preferably consists of an alicyclic polyisocyanate. It advantageously consists of dicyclohexyl-methylene diisocyanate (MCDI);
at least one plasticizer: said at least one plasticizer is preferentially chosen from dioctyl azelate (DOZ), diisooctyl sebacate, isodecyl pelargonate, polyisobutylene and dioctyl phthalate (DOP);
at least one additive: said at least one additive may especially consist of one or more agents for adhering between the binder and the oxidizing charge, for instance bis(2-methylaziridinyl)methylamino-phosphine oxide (methyl BAPO) or triethylenepentamineacrylonitrile (TEPAN), of one or more antioxidants derived from those of the rubber industry, for instance di-tert-butyl-para-cresol (DBC) or 2,2′-methylene-bis(4-methyl-6-tert-butylphenol) (MBP5), of one or more crosslinking catalysts, for instance iron or copper acetylacetonate, dibutyltin dilaurate (DBTL), of one or more combustion catalysts, for instance iron oxide, etc.

Said ingredients are incorporated in the standard amounts (weight percentages) indicated above.

It is noted here, incidentally, that the list of ingredients given above is not exhaustive. Thus, it is not excluded for another energetic charge to be introduced into the mixer.

With reference to the technical problems mentioned above, the charge of ammonium perchlorate is, in the context of the process of the invention, optimized: it is obtained from at least a first and second (or even third) charge each having a monomodal particle size distribution as stated above. It results, characteristically, from the introduction, into the mixer, separately or as a mixture, of at least two charges of different monomodal particle size: the first of category A (see above) and the second of category B (see above). The introduction of a third charge of category C (see above) is expressly envisioned. The introduction of at least one other charge (in addition to those of categories A, B and C) is not excluded from the context of the invention. In principle, it is sparingly beneficial.

Characteristically, the charge of ammonium perchlorate in the mixture, in the mixer, is, at least partly, advantageously totally, formed from a first and second charge (each) of specific monomodal particle size, or even from a first, second and third charge (each) of specific monomodal particle size.

The mixture (binary or ternary) of the first and second or first, second and third oxidizing charges of different specific monomodal particle size may be produced in advance. According to this variant, the oxidizing charge of the propellant is produced in advance and is then added, preconstituted, into the mixer.

The mixture (binary or ternary) of the first and second or first, second and third oxidizing charges of different specific monomodal particle size may be produced only in the mixer within the paste. According to this variant, it is not preconstituted. The first, second, or even third, charges may thus be introduced separately. In the context of this variant, when three types of oxidizing charge are introduced, it is, however, possible to preconstitute a binary mixture of first and second, first and third or second and third oxidizing charges of specific monomodal particle size. Said mixture is then added to the mixer, followed, respectively, by the third, the second or the first oxidizing charge (the complementary oxidizing charge) such that said first, second and third charges constitute the oxidizing charge of the propellant.

It is understood that the above notions of separate introduction or of introduction as a mixture (binary or ternary mixtures) cover all these variants.

The inventors have, to their credit, identified the monomodal particle size categories A, B and C of ammonium perchlorate and demonstrated their value in the constitution of the oxidizing charge of a solid composite aluminized propellant.

According to one advantageous variant, the oxidizing charge of ammonium perchlorate in the paste results only from the introduction into the mixer (separately or as a mixture) of the first and second charge whose monomodal particle size has been stated above (by means of the ranges of values D₁₀, D₅₀ and D₉₀).

As regards the respective amounts used of said first, second, or even third, oxidizing charges, it is possible, in an entirely nonlimiting manner, to state the following.

The oxidizing charge of ammonium perchlorate (100%) in the paste results generally from the introduction into the mixer, separately or as a mixture, of:
12% to 70% by weight of said first charge (category A),
10% to 81% by weight of said second charge (category B),
0 to 23% by weight of said third charge (category C).

It may especially result from the introduction into the mixer, separately or as a mixture, of:
20% to 65% (or even 20% to 60%) by weight of said first charge (category A),
35% to 80% (or even, respectively, 40% to 80%) by weight of said second charge (category B),
0 to 22% by weight of said third charge (category C).

The oxidizing charge of ammonium perchlorate (100%) in the paste results, very generally, from the introduction into the mixer, separately or as a mixture, of:
12% to 61% by weight of said first charge (category A),
36% to 81% by weight of said second charge (category B),
0 to 23% by weight of said third charge (category C).

In the context of the advantageous variant mentioned above (intervention of the first and second oxidizing charges only), the oxidizing charge of ammonium perchlorate (100%) in the paste results preferably from the introduction into the mixer, separately or as a mixture, of:
20% to 65% by weight of said first charge (category A),
35% to 80% by weight of said second charge (category B); even more preferably of:
42% to 61% by weight of said first charge (category A),
39% to 58% by weight of said second charge (category B).

The particle size of the aluminum charge (it is recalled here that different aluminum charges of monomodal particle size distribution may also be involved (see the examples below)) is a second-order parameter, with reference to the technical problems mentioned above. The aluminum particles generally have a median diameter of less than or equal to 40 μm. The best results, going as far as the production of alumina with a monomodal particle size centered at about 1 to 3 μm, are obtained with aluminum particles with a median diameter of between 1 and 10 μm and certain combinations of ammonium perchlorate of categories A and B (see the examples below) introduced into the mixer to form the ammonium perchlorate charge.

Said aluminum charge thus generally has a median diameter (D₅₀) of less than or equal to 40 μm, advantageously between 1 and 10 μm. The D₁₀ and D₉₀ values for said aluminum charge advantageously correspond, respectively, to at least ¼ and to not more than 4 times said mean diameter.

According to its second subject, the present invention relates to solid aluminized propellants that may be obtained via the above process, this process involving oxidizing charges of ammonium perchlorate with specific different monomodal particle sizes.

The process of the invention, as described above, in fact leads to novel solid composite propellants. Such solid composite propellants—with a polyurethane binder filled with ammonium perchlorate and aluminum—whose combustion generates less than 15% and generally between 2% and 10% by volume of alumina particles whose diameter is greater than 10 μm, are claimed per se. Their diameter (equivalent spherical) is measured by means of a photon correlation optical granulometer (see hereinafter and hereinbelow).

The solid propellants of the invention generally have rates of combustion of between 6 and 12 mm/s and pressure exponents of between 0.15 and 0.4 and advantageously between 0.2 and 0.4, over an operating pressure range from 3 to 10 MPa, which corresponds to the standard values of ballistic parameters. The major interest of the process of the invention is thus that of allowing the production of solid propellants that have such ballistic properties and whose combustion generates alumina particles of small particle size.

The particle size of the alumina produced by combustion of the propellants of the invention was determined by means of measuring equipment recognized by the international community, known as a “rotary trap” or “quench particle combustion bomb”. It was developed by the company Morton Thiokol (see P. C. Braithwaite, W. N. Christensen, V. Daugherty (Morton Thiokol), Quench bomb investigation of aluminium oxide formation from solid rocket propellants (part I): experimental methodology, 25th JANNAF combustion meeting, CPIA Publication 498, vol. 1, p. 175, October 1988). The principle consists in burning a small sample of propellant at the end of a rod fixed in a chamber at room temperature, which is pressurized, generally with nitrogen. A bowl containing alcohol rotates around the sample. The distance between the sample and the alcohol film formed on the wall of the bowl is adjustable. Most of the drops ejected from the combustion surface impact on the rotating liquid. After the test, the liquid is recovered and the particles analyzed.

The particle size distribution, by volume, of the recovered particles is then measured using a photon correlation optical granulometer (PCS-DLS: Photon Correlation Spectroscopy-Diffusion Light Scattering).

The solid propellants of the invention produce, during their combustion, particles of smaller size than those produced by the combustion of prior art propellant of the same type. The percentage of the total volume (passing) corresponding to particles with a diameter (equivalent spherical) of greater than 10 μm is thus less than 15% and generally between 2% and 10% for the propellants of the invention, which is much lower than that of the reference propellants of the prior art (˜30%).

The particle size curves for the particles produced by the combustion of the propellants of the invention always show, like those of the propellants of the prior art, a granulometric peak centered at about 0.1 to 3 μm. For certain propellants of the invention, as for the propellants of the prior art, a second granulometric peak corresponding to particles with a diameter of greater than 10 μm is also observed. This second peak is centered at about 10 to 50 μm for the propellants of the invention, these values being less than those (60 to 100 μm) observed for the propellants of the prior art. The preferred propellants of the invention do not have said second granulometric peak and therefore produce only a residual percentage of particles larger than 10 μm in diameter.

According to another of its subjects, the invention relates to a solid propellant charge containing a solid propellant of the invention.

According to yet another of its subjects, the invention relates to a rocket engine comprising at least one charge containing a propellant of the invention.

Finally, a subject of the invention is an oxidizing charge of ammonium perchlorate, which is especially useful in the process for obtaining a solid composite propellant of the invention as described above, and which is especially useful for obtaining a solid composite propellant of the invention as described above. Said charge may be obtained by mixing at least two charges chosen from the first, second and third charges as defined above (binary or ternary mixtures), which may be advantageously obtained by mixing at least a first charge and at least a second charge (binary mixtures) and optionally at least a third charge (ternary mixtures) as defined above, which may be very advantageously obtained by mixing at least a first charge and at least a second charge (binary mixtures) as defined above. It also advantageously contains said charges in the weight proportions mentioned above.

The invention is now described, without any limitation whatsoever, with reference to the attached figures and to the examples below.

FIG. 1 shows a scheme of the combustion of a drop of aluminum.

FIG. 2 illustrates the phenomena producing the various particle sizes of alumina generated during the combustion of a solid propellant.

FIG. 3 shows the particle size curves by volume, measured using a photon correlation optical granulometer (PCS-DLS: Photon Correlation Spectroscopy-Diffusion Light Scattering), for the particles produced by the preferred propellant of the invention (see example 9 below) in comparison with those produced with a reference propellant of the prior art (see below).

The following are referenced in FIG. 1: at 1, the solid propellant, at 2, the combustion surface of said solid propellant, at 3, a drop of aluminum in combustion, at 4, the alumina cap at the base of said drop 3, at 5, the flame, and at 6, the smoke plume.

FIG. 2 shows, at 1, the solid propellant, at 2, its combustion surface, at 3, aluminum drops, at 4, the alumina cap at the base of the drops 3 in combustion. Said FIG. 2 shows, at 3′, an agglomerated aluminum drop, at 7, smoke charged with small particles (diameter of about 1 μm) and, at 8 and 8′, residual oxide particles (diameter of about 0.5-4 μm and 40-100 μm, respectively).

It is now proposed to illustrate the invention by the examples (examples of formulation of propellants of the invention) below.

Table 1 below gives the mass percentages of the constituents (PA, Al) of solid propellants according to the invention, the ballistic properties of said propellants and the particle sizes of the alumina produced during the combustion of said propellants. These same data are indicated for three reference propellants. The solid propellants of table 1 are solid composite propellants with a polyurethane binder and contain an oxidizing charge of ammonium perchlorate and an aluminum charge.

The reference propellants 1 and 2 have a standard composition. They are of the type used for space applications. The reference propellant 3 shows the influence of the substantial presence (42%) of small particles of ammonium perchlorate on the rate of combustion (logically, small alumina particles are then obtained).

The solid propellants of the invention according to examples 1 to 12 have rates of combustion and pressure exponents measured at 5 MPa in the expected ranges of rate and exponent for the targeted field of application, similar to those of the reference propellants 1 and 2.

The last line of table 1 relates to the propellant M12 of table 3 of Massa et al. (Journal of Propulsion and Power, vol. 24, No. 2, March-April 2008). It contains ammonium perchlorate particles of 200 μm (26.92%=27%) and 82.5 μm (40.38%=40%) and also aluminum particles of 3 μm (20%).

The particle size envelopes of the aluminum charges referenced in table 1 are indicated in table 2.

The alumina particles produced by the solid propellants of table 1 were recovered using a pressurized chamber equipped with a trapping means (“rotary trap” test means described previously). The procedure for capturing the particles is as follows:
the test propellant sample is in the form of a cube (with a side length of one centimeter) with no inhibited face;
the sample holder onto which the test sample is stuck is placed inside the rotary trap;
during the test, the alcohol contained in the rotary trap becomes lined, in the form of a film (about 2 mm thick), on the side walls of the bowl, by virtue of this rotation;
the pressure inside the chamber is set at 5 MPa relative. The pressurization is achieved with nitrogen and the distance between the propellant sample and the alcohol film is 20 mm at the start of combustion. The particles emitted are sampled horizontally;
the free face of the propellant cube opposite the alcohol film is ignited (the very short duration of the combustion makes it possible to maintain a virtually constant combustion surface).

The recovery principle consists in recovering in the alcohol the particles of the condensed phase emitted in the combustion gases of the propellant sample.

The particle size distribution, by volume, of the recovered particles is then measured using a photon correlation optical granulometer (PCS-DLS: Photon Correlation Spectroscopy-Diffusion Light Scattering).

Before being introduced into the granulometer, the residues recovered in suspension in the ethanol are subjected to ultrasonication.

With reference to FIG. 3, the distribution or particle size distribution of the particles collected in the ethanol during the combustion of the propellant is expressed in the form of two curves: on the one hand, the histogram giving the volume fraction of particles as a function of the category of equivalent spherical diameter of the analyzed particles, and, on the other hand, the curve giving the cumulative volume fraction as a function of the category of equivalent spherical diameter of the analyzed particles.

FIG. 3 shows the curves obtained for the reference propellant 1 and that of example 9 according to the invention.

Table 1 shows the characteristic values recorded on the particle size curves for the recovered particles produced by the combustion of the reference solid propellants and for the examples according to the invention (see the last three columns of said table 1).

The compositions of the solid propellants of table 1 are given by the weight percentage of the ammonium perchlorate charge and the constitution of this charge (category A/B/C), the weight percentage of aluminum and its particle size category (stated in table 2), the remainder to 100% of the weight being formed of the hydroxytelechelic polybutadiene polyol polymer PBHT R45HTLO sold by the company Sartomer, the crosslinking agent MDCI, the plasticizer DOZ and additives.

The particle size histograms always show at least one granulometric peak for diameters less than 10 μm. The values indicated in the “Dpeak<10 μm” column of table 1 correspond to the value or to the range of values (when there are several peaks, or when a dispersion of values is measured over several tests) of the maximum or maxima of said at least one granulometric peak for measured diameters of less than 10 μm. When the particle size curve shows more than one granulometric peak for particles greater than 10 μm in diameter, the value or the range of values recorded (for example recorded over several tests) of the diameter of the maximum of said granulometric peak for particles greater than 10 μm in diameter is indicated in the “Dpeak>10 μm” column of table 1.

The values recorded for “Dpeak<10 μm” for the propellants of the invention are similar to the reference values. On the other hand, the “Dpeak>10 μm” values for the propellants of the invention are all less than those of the references 1 and 2. For examples 7, 8, 9, 11 and 12 according to the invention, no granulometric peak greater than 10 μm is observed.

The solid propellants of the invention produce a reduced amount of alumina particles greater than 10 μm in diameter, relative to the reference propellants 1 and 2. This is expressed, in table 1, by the value of the percentage of volume (passing volume recorded on the curve giving the cumulative volume fraction as a function of the equivalent spherical diameter category of the analyzed particles) corresponding to the categories of particles greater than 10 μm in diameter. All the propellants of the invention lead to a percentage of passing volume corresponding to particles greater than 10 μm in diameter which is very much less than that of the reference propellant.

Among the solid propellants listed in table 1, the value of those of examples 8 and 9 may be noted, which show a rate of combustion similar to that of the reference propellants (1 and 2) and produce a very small percentage of particles greater than 10 μm in diameter.

The propellant M12 of table 3 of Massa et al. (Journal of Propulsion and Power, vol. 24, No. 2, March-April 2008) contains two ammonium perchlorate charges formed from ammonium perchlorate with particle size distributions centered, respectively, on 200 μm and 82.5 μm (and thus centered in the D₅₀ range for the charges of categories A and B according to the invention).

Said propellant M12 has a rate of combustion of 14 mm/s at 40 MPa (FIG. 12c). Since the rate of combustion of solid propellants increases with the pressure, the rate of combustion of the propellant M12 at a pressure of 5 MPa (reference pressure for the examples of the invention) is inevitably greater than this value of 14 mm/s. It is therefore very much higher than those of the reference propellants 1 and 2.

This shows that the selection of ammonium perchlorate charges solely on the criterion of their median diameter (D₅₀) is insufficient to ensure both a rate of combustion very close to that of the reference propellants 1 and 2 and a very small percentage of alumina particles produced with a diameter of greater than 10 μm (it is recalled here, incidentally, that Massa et al. gives no information regarding the particle size of the alumina produced). It is therefore by selecting ammonium perchlorate charges of suitable D₁₀, D₅₀ and D₉₀ spectra that the Applicant has achieved the desired objective.

TABLE 1

| | Weight content of | | | | | | |
|---|---|---|---|---|---|---|---|
| | ammonium | | | | | | |
| | perchlorate | | | | | | |
| | and weight | Weight | | | | | |
| | distribution of the | content and | | | | | % |
| | particle size | particle size | Vc | n | D peak | D peak | passing |
| | categories | category | 5 MPa | | <10 μm | >10 μm | volume |
| | A/B/C | of aluminum | mm/s | | μm | μm | >10 μm |
| Ref. 1 | 68% | 18% | 7.9 | 0.35 | 0.8-1.5 | 60-80 | 29 |
| | 85/0/15 | (D) | | | | | |
| Ref. 2 | 60% | 18% | 8.3 | 0.35 | 0.8-1.5 | 20-80 | 22 |
| | 85/0/15 | (E) | | | | | |
| Ref. 3 | 69% | 19% | 11.8 | 0.34 | 1.68 | — | 6 |
| | 58/0/42 | (I) | | | | | |
| Ex. 1 | 68% | 18% | 11.1 | 0.24 | 1.2-2.0 | 20-40 | 6 |
| | 41/37/22 | (E) | | | | | |
| Ex. 2 | 68% | 18% | 10.3 | 0.27 | 1.5-2.0 | 10-40 | 4 |
| | 25/60/15 | (F) | | | | | |
| Ex. 3 | 68% | 18% | 11 | 0.28 | 1.5-2.0 | 20-40 | 5 |
| | 30/50/20 | (E) | | | | | |
| Ex. 4 | 68% | 18% | 10.8 | 0.26 | 1.5-2.5 | 10-40 | 2 |
| | 13/80/7 | (F) | | | | | |
| Ex. 5 | 68% | 18% | 7.4 | 0.16 | 1.3 | 45 | 10 |
| | 50/50/0 | (F) | | | | | |
| Ex. 6 | 68% | 18% | 7.8 | 0.22 | 1.5 | 35 | 4 |
| | 43/57/0 | (F) | | | | | |
| Ex. 7 | 68% | 18% | 10.8 | 0.29 | 1.45 | — | 5 |
| | 13/80/7 | (E) | | | | | |
| Ex. 8 | 69% | 19% | 8.4 | 0.25 | 0.3 | — | 3 |
| | 60/40/0 | (F) | | | | | |
| Ex. 9 | 70% | 16% | 7.8 | 0.26 | 0.3-2.0 | — | 3 |
| | 60/40/0 | (F) | | | | | |
| Ex. 10 | 68% | 18% | 7.1 | 0.33 | 0.4 | 55 | 7 |
| | 50/50/0 | (mixture | | | | | |
| | | 50% F/50% G) | | | | | |
| Ex. 11 | 69% | 19% | 9.6 | 0.3 | 1.44 | — | 5.5 |
| | 69.6/11.6/18.8 | (mixture | | | | | |
| | | 50% H/50% I) | | | | | |
| Ex. 12 | 69% | 19% | 9.9 | 0.27 | 1.24 | — | 10.8 |
| | 69.6/11.6/18.8 | (mixture | | | | | |
| | | 50% H/50% J) | | | | | |
| M12 | 67% | 20% | 14 (to | | | | |
| | 27% 200 μm | 3 μm | 4 MPa) | | | | |
| | 40% 82.5 μm | | | | | | |

TABLE 2
Particle size categories of the aluminum charges used
for the reference and examples 1 to 10 of table 1

| | | | |
|---|---|---|---|
| D | 13.9 < D₁₀ < 17.7 | 33.7 < D₅₀ < 42.9 | 72.5 < D₉₀ < 86.4 |
| E | 2.5 < D₁₀ < 3.7 | 4.5 < D₅₀ < 7.3 | 9.0 < D₉₀ < 16.0 |
| F | 3.0 < D₁₀ < 4.5 | 7.5 < D₅₀ < 10.0 | 11.0 < D₉₀ < 19.0 |
| G | 13.0 < D₁₀ < 15.0 | 38 < D₅₀ < 50 | 85.0 < D₉₀ < 100.0 |
| H | 0.3 < D₁₀ < 0.6 | 3.5 < D₅₀ < 7 | 84 < D₉₀ < 100 |
| I | 9 < D₁₀ < 11 | 14.5 < D₅₀ < 16.5 | 23 < D₉₀ < 26 |
| J | 7.5 < D₁₀ < 9 | 30 < D₅₀ < 32 | 81 < D₉₀ < 85 |

1. A process for obtaining a solid composite propellant, comprising:
the production of a paste by blending, in a mixer, a mixture containing a liquid polyol polymer, an oxidizing charge of ammonium perchlorate, a reducing charge of aluminum, at least one agent for crosslinking said liquid polyol polymer in an amount such that the NCO/OH bridging ratio is between 0.8 and 1.1, at least one plasticizer and at least one additive;
pouring of the paste obtained into a mold;
thermal crosslinking of said paste in said mold;
characterized in that said oxidizing charge of ammonium perchlorate in said paste results from the introduction, into said mixer, separately or as a mixture, of at least:
a first charge whose monomodal particle size distribution has a D₁₀ value of between 100 μm and 110 μm, a D₅₀ value of between 170 μm and 220 μm and a D₉₀ value of between 315 μm and 340 μm, and
a second charge whose monomodal particle size distribution has a D₁₀ value of between 15 μm and 20 μm, a D₅₀ value of between 60 μm and 120 μm and a D₉₀ value of between 185 μm and 220 μm; and, optionally,
a third charge whose monomodal particle size distribution has a D₁₀ value of between 1.7 μm and 3.6 μm, a D₅₀ value of between 6 μm and 12 μm and a D₉₀ value of between 20 μm and 32 μm.

2. The process as claimed in claim 1, characterized in that said oxidizing charge of ammonium perchlorate in said paste results from the introduction into said mixer, separately or as a mixture, of said first charge and of said second charge.

3. The process as claimed in claim 1, characterized in that said oxidizing charge of ammonium perchlorate in said paste results from the introduction into said mixer, separately or as a mixture, of:
12% to 70% by weight of said first charge,
10% to 81% by weight of said second charge,
0 to 23% by weight of said third charge.

4. The process as claimed in claim 1, characterized in that said oxidizing charge of ammonium perchlorate in said paste results from the introduction into said mixer, separately or as a mixture, of:
12% to 61% by weight of said first charge,
36% to 81% by weight of said second charge,
0 to 23% by weight of said third charge.

5. The process as claimed in claim 1, characterized in that said oxidizing charge of ammonium perchlorate in said paste results from the introduction into said mixer, separately or as a mixture, of:
20% to 65% by weight of said first charge, and
35% to 80% by weight of said second charge.

6. The process as claimed in claim 5, characterized in that said oxidizing charge of ammonium perchlorate in said paste results from the introduction into said mixer, separately or as a mixture, of:
42% to 61% by weight of said first charge,
39% to 58% by weight of said second charge.

7. The process as claimed in any one of claim 1, characterized in that said reducing charge of aluminum has a median diameter of less than or equal to 40 μm.

8. A solid composite propellant with a polyurethane binder filled with ammonium perchlorate and with aluminum, which may be obtained via the process as claimed in any one of claim 1.

9. The solid propellant as claimed in claim 8, whose combustion generates less than 15% by volume of alumina particles greater than 10 μm in diameter.

10. The solid propellant as claimed in claim 8, characterized in that, over an operating pressure range from 3 to 10 MPa, its rate of combustion is between 6 and 12 mm/s and its pressure exponent is between 0.15 and 0.4.

11. A solid propellant charge, characterized in that it contains a solid propellant as claimed in any one of claim 8.

12. A rocket engine, characterized in that it comprises at least one charge as claimed in claim 11.

13. An oxidizing charge of ammonium perchlorate, which is especially useful in the process for obtaining a solid composite propellant as claimed in any one of claims 1, which may be obtained by mixing at least two charges chosen from the first, second and third charges as defined in claim 1, which may be advantageously obtained by mixing at least a first charge and at least a second charge and optionally at least a third charge as defined in claim 1, which may be very advantageously obtained by mixing at least a first charge and at least a second charge as defined in claim 1.

14. The oxidizing charge as claimed in claim 13, containing said first, second and optionally third charges in the mass percentages indicated in claim 3.

15. The process as claimed in claim 1, wherein the NCO/OH bridging factor is 1.

16. The process as claimed in claimed 7, wherein the median diameter is between 1 and 10 μm.

17. The process as claimed in claimed 7, wherein the reducing charge of aluminum has D₁₀ and D₉₀ values of its particle size distribution corresponding, respectively, to at least a quarter of the value of the median diameter and to not more than 4 times the value of said median diameter.

18. The solid propellant as claimed in claim 9, wherein the volume is between 2% and 10%.

19. The solid propellant as claimed in claim 10, wherein the pressure exponent is between 0.2 and 0.4.
